(19) United States
(12) Patent Application Publication
(10) Pub. No.: US 2026/0027915 A1
(43) Pub. Date: Jan. 29, 2026

(54) BATTERY ELECTRIC DUMP TRUCK

(71) Applicant: Liebherr Mining Equipment Newport News Co., Newport News, VA (US)

(72) Inventors: Bennet Yeung, Newport News, VA (US); Kevinkumar Patel, Newport News, VA (US); Simon Ardyna, Newport News, VA (US); Matthew Fuller, Newport News, VA (US)

(21) Appl. No.: 19/278,350

(22) Filed: Jul. 23, 2025

Related U.S. Application Data
(60) Provisional application No. 63/676,152, filed on Jul. 26, 2024.

(51) Int. Cl. B60L 50/60; B60K 1/04; B60P 1/04; B62D 65/10

(52) U.S. Cl. CPC B60L 50/66; B60K 1/04; B60P 1/04; B62D 65/10; B60K 2001/0411; B60K 2001/0416; B60L 2200/40

(57) ABSTRACT

The present disclosure relates to a dump truck, comprising a frame, a dump body pivotably mounted on the frame, and a power unit providing electrical energy to at least one electrical propulsion motor of the battery electric dump truck, wherein the power unit is mounted on cantilevered mounts attached to the frame, wherein the cantilevered mounts are bolted to the frame.

### CROSS REFERENCE TO RELATED APPLICATION

The present application claims priority to U.S. Provisional Application No. 63/676,152, entitled “A BATTERY ELECTRIC DUMP TRUCK”, and filed on Jul. 26, 2024. The entire contents of the above-listed application are hereby incorporated by reference for all purposes.

### BACKGROUND OF THE DISCLOSURE

The present disclosure relates to a battery electric dump truck and methods related to battery electric dump trucks.

Dump trucks are usually powered by a combustion engine, such as a Diesel engine. In most applications, the Diesel engine will drive a generator, which in turn will drive electric propulsion motors for driving the dump truck. An example of such a diesel electric dump truck is described in the brochure T 284—Liebherr Mining Truck, LME-11481630-enGB08-2022, Liebherr Mining Equipment Newport News Co.

In order to reduce the environmental load of dump trucks, there have been attempts to power dump trucks using batteries. Battery electric dump trucks and battery electric trucks are know from e.g. from documents CN218505646 U, WO2022036364 A1, U.S. Pat. No. 11,220,167 B2 and U.S. Pat. No. 11,541,739 B2. Document US 2023/0339308 A1 and WO 2023074203 A1 show a dump truck with a hybrid hydrogen fuel cell/battery based power plant.

### BRIEF SUMMARY OF THE DISCLOSURE

An object of the present disclosure is to provide an improved battery electric dump truck and related methods.

In a first aspect, the present disclosure comprises a battery electric dump truck comprising a frame, a dump body pivotably mounted on the frame, a power unit comprising a battery, the power unit providing electrical energy to at least one electrical propulsion motor of the battery electric dump truck, and a radiator unit, wherein the radiator unit comprises two radiator columns spaced apart from each other, with an installation opening for the power unit being arranged between the radiator columns.

In a second aspect, the present disclosure comprises a dump truck comprising a frame, a dump body pivotably mounted on the frame, a power unit providing electrical energy to at least one electrical propulsion motor of the battery electric dump truck, wherein the power unit is mounted on cantilevered mounts attached to the frame, wherein the cantilevered mounts are bolted to the frame. Because the cantilevered mounts are bolted on to the inner side walls of the side beams, they can be replaced to account for different power unit mounting needs. In particular, this may provide modular, field replaceable structural mounts to accept a variety of power unit types.

In a third aspect, the present disclosure comprises a battery electric dump truck comprising a frame, a dump body pivotably mounted on the frame, a power unit comprising a battery, the power unit providing electrical energy to at least one electrical propulsion motor of the battery electric dump truck, and a hydraulic pump operated by an electric motor, wherein the hydraulic pump and the electric motor are mounted to the power unit. In particular, the electric motor/pump may be mounted to the rear of the power unit. The third aspect may enable a quick removal/replacement of entire power unit. The hydraulic system may be agnostic to the type of power system used, and may have the same location as if driven by a combustion engine.

In a fourth aspect, the present disclosure comprises a battery electric dump truck comprising a frame, front and rear wheels mounted on the frame, a dump body pivotably mounted on the frame, a power unit comprising a battery, the power unit providing electrical energy to at least one electrical propulsion motor of the battery electric dump truck, and at least one additional battery unit, wherein the at least one additional battery unit is attached to the frame at a position between the front and the rear wheels using a first bracket comprising pins inserted in hooks provided on the frame.

In a fifth aspect, the present disclosure comprises a method for installing or de-installing a power unit to or from a battery electric dump truck, the battery electric dump truck comprising a frame and a dump body pivotably mounted on the frame, and the power unit comprising a battery and providing electrical energy to at least one electrical propulsion motor of the battery electric dump truck, the method comprising the step of inserting the power unit from a front side of the battery electric dump truck or removing the power unit to a front side of the battery electric truck via an insertion opening provided between two radiator columns of the battery electric dump truck, the radiator columns being provided on a front side of the battery electric dump truck.

In a sixth aspect, the present disclosure comprises a method for manufacturing a dump truck, in particular a battery electric dump truck, the dump truck comprising a frame and a dump body pivotably mounted on the frame, and a power unit providing electrical energy to at least one electrical propulsion motor of the battery electric dump truck, the method comprising the steps of providing a frame, choosing the power unit from a battery electric power unit and a combustion engine power unit, and mounting the power unit on the frame, wherein the frame is identical for the battery electric power unit and the combustion engine power unit. The dump truck may in particular be designed in modular fashion such that it can be converted after manufacture to be powered from a diesel electric or battery electric power unit or a fuel cell hybrid power unit.

The battery electric dump truck of the present disclosure may in particular be used on a mine site, in particular for open mining operations.

The battery electric dump truck of the present disclosure may have a maximum payload of 50 metric tons or more, in particular of 100 metric tons or more, in particular of 200 metric tons or more, in particular of 300 metric tons or more.

The battery electric dump truck of the present disclosure may have an empty vehicle weight of 50 metric tons or more, in particular of 100 metric tons or more, in particular of 200 metric tons or more.

Embodiments of the present disclosure will now be described with reference to the following drawings.

### BRIEF DESCRIPTION OF THE FIGURES

The drawings show:

FIG. 1 a perspective drawing of an embodiment of a battery electric dump truck,

FIG. 2A a perspective drawings of the frame of the embodiment of a battery electric dump truck of FIG. 1,

FIG. 2B a perspective drawing of the frame of the embodiment of a battery electric dump truck of FIG. 1, with the power unit and additional battery units attached to the frame,

FIG. 3 an enlarged view of the front part of the embodiment of a battery electric dump truck of FIG. 1, with a staircase element removed, showing the split radiator unit,

FIG. 4 the same view as FIG. 3, but with the staircase element attached,

FIG. 5 an embodiment of the radiator unit used for the embodiment of the battery electric dump truck of FIG. 1,

FIG. 6A and FIG. 6B embodiments of bolted-on cantilevered mounts for mounting power units to the frame as shown in FIG. 2A and FIG. 2B,

FIG. 7 a perspective view showing an embodiment of a hydraulic unit attached at the back side of a power unit,

FIG. 8 an enlarged view of the embodiment of a hydraulic unit shown in FIG. 7 and

FIG. 9 an embodiment of an additional battery unit with mounting brackets for mounting the additional battery unit to the frame as shown in FIG. 2A and FIG. 2B.

### DETAILED DESCRIPTION OF THE DISCLOSURE

In a general aspect, the embodiments of a battery electric dump truck of the present disclosure comprise a frame 10, a dump body 20 pivotably mounted on the frame 10, and a power unit 30 comprising a battery, the power unit 30 providing electrical energy to at least one electrical propulsion motor 4 of the battery electric dump truck.

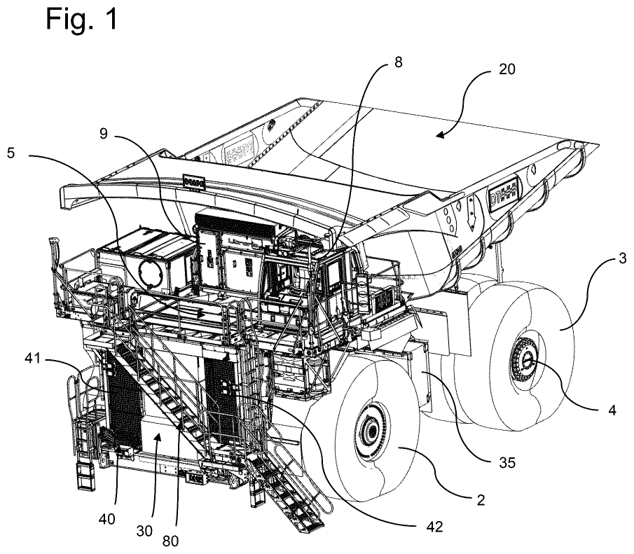

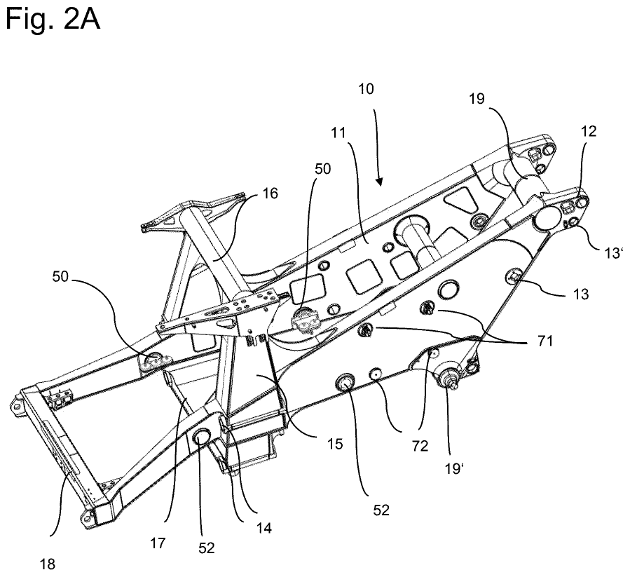

Details of the embodiment of the battery electric dump truck and the frame shown in FIG. 1 and FIG. 2A are described in the following. However, the aspects of the present disclosure described in the following may also be implemented with other embodiments of a battery electric dump truck or a frame.

In the embodiment, the frame or chassis 10 is a steel construction formed by welding steel elements to each other. Some of the steel elements may be casted elements, others may be steel plates. The beams of the frame may have, in cross section, a box construction, a T-construction or a H-construction.

In the embodiment, the power unit 30 does not comprise a combustion engine, such that the dump truck is a fully electric dump truck. Further, the batteries of the dump truck may be the only on-board power source of the dump truck. However, the dump truck may additionally comprise a trolley system to provide electrical energy via power lines and the trolley system.

In the embodiment, the power unit 30 comprises a battery unit 33 for powering electric traction motors of the dump truck. The power unit may further comprise a power distribution cabinet 31 and/or a thermal conditioning unit 32.

In the embodiment, the battery electric dump truck shown in FIG. 1 comprises front wheels 2 and rear wheels 3, with at least the rear wheels driven by the propulsion motors 4. The front wheels 2 are steered by a steering system.

On a level above the front wheels 2, the battery electric dump truck comprises a deck 5 carrying an operator cabin 8 and/or a control cabinet 9. Further functional units may be mounted on the deck 5.

In a manual mode, the battery electric dump truck is controlled by an operator from the operator cabin 8, using manual control elements such as a steering wheel, an accelerator pedal and/or a brake pedal for controlling a propulsion system and a steering system of the battery electric dump truck and thereby the speed and the direction of the battery electric dump truck.

The battery electric dump truck may also comprise an autonomous mode, wherein a controller of the battery electric dump truck autonomously controls the propulsion system and a steering system of the battery electric dump truck and thereby the speed and the direction of the battery electric dump truck. For example, the controller may be configured to autonomously control the battery electric dump truck along a mission from a loading site to an unloading site or vice versa. The controller may further be configured to autonomously control the battery electric dump truck to travel to a charging station and autonomously perform a charging operation in collaboration with the charging station. In autonomous mode, the controller of the battery electric dump truck may be in communication with a central mission controller to receive the missions to be performed by the battery electric dump truck.

The controller may comprise a microprocessor and a computer program stored on non-transitory memory, the computer program comprising code that will, when executed on the microprocessor, provide the functionality described above and in the following. The controller may be connected to input devices located in the operator cabin of the dump truck, and may control actuators of the dump truck such as steering actuators and the electric propulsion motors 4 for controlling steering and propulsion.

On a front side of the battery electric dump truck, a radiator unit 40 is provided. Further, in front of the radiator unit 40, a staircase element 80 leads to the deck 5.

As a part of some of the aspects of the present disclosure described more fully in the following, the battery electric dump truck comprises the power unit 30 and, in the embodiment, additional battery units 35 arranged between the front wheels 2 and the rear wheels 3 on the frame 10.

The frame of the battery electric dump truck is shown in FIG. 2A. In the embodiment, it comprises two side beams 11 extending in a longitudinal direction of the battery electric dump truck. In the embodiment, the side beams extend from a front end of the dump truck to a rear end, with the dump body being pivotably mounted to pivot mounts 12 arranged at the rear end of the sides frames.

As can be seen from FIG. 2B, the power unit 30 is arranged between the side beams 11 of the frame.

In the embodiment, the frame 10 comprises an upper bridge member connecting the two side beams 11 in a lateral direction, the upper bridge member comprising side pillars 15 extending upwards from the side beams 11 and an upper cross beam 16 connecting the side pillars. Further, at the same longitudinal position of the frame, the side beams are connected by a lower bridge member formed by a lower extension of the side pillars connected by a lower cross beam 17. The upper bridge member and the lower bridge member therefore together form a frame structure extending in an up-down direction and a lateral direction of the battery electric dump truck.

The deck and the operator cabin are mounted on the upper cross beam 16 of the upper bridge member.

Further, connection points 14 for the suspension system of the front wheels 2 are provided on the pillars 15. A suspension system of the rear wheels is mounted to connection points 13, 13′ provided on the side beams 11.

In the embodiment, the side beams 11 are connected in the lateral direction by at least a first rear cross member 19 and a second rear cross member 19′.

In the embodiment, the side beams 11 have, in side view, an essentially triangular shape extending between a front end, the first rear cross member 19 and the second rear cross member 19′. A longer side of the triangular shape is directed to an upper side, a first shorter side is directed to a lower side, and a second shorter side is directed to the rear. The longer side therefore extends upwards in a front-rear direction.

In the embodiment, the first rear cross member 19 is arranged at a rear corner adjacent to the pivot mounts 12 of the dump body and the second rear cross member 19′ is arranged at a lower corner of the triangular shape and comprises at its lateral ends pins for carrying the lower ends of dump hoist cylinders for hosting the dump body 20.

In the embodiment, front ends of the side beams 11 are connected by a front cross member 18.

Aspects of the present disclosure, which can be implemented with the embodiment of a battery electric dump truck shown in FIG. 1 and a frame shown in FIG. 2A or other embodiments of a battery electric dump truck are described in the following.

In a first aspect, as shown in FIG. 1 and FIG. 3 to FIG. 5, the battery electric dump truck comprises a split radiator unit 40 comprising two radiator columns 41 and 42 spaced apart from each other, with an installation opening 45 for the power unit 30 being arranged between the radiator columns 41 and 42. Thereby, the power unit 30 can be installed or de-installed from the battery electric dump truck without having to de-install the radiator unit.

Thereby, the installation or de-installation time for the power unit is considerably shortened. Because of the batteries contained in the power unit, the performance of which degrades over time, the power unit has to be replaced a number of times during the service life of the battery electric dump truck. Shortening the installation and de-installation time for the power unit therefore increases the availability of the battery electric dump truck.

In the embodiment, the power unit may be inserted into an installation space between the side beams 11 of the frame 10 or removed from this installation space with the radiator unit still mounted to the frame, via the installation opening 45 provided between the radiator columns 41 and 42.

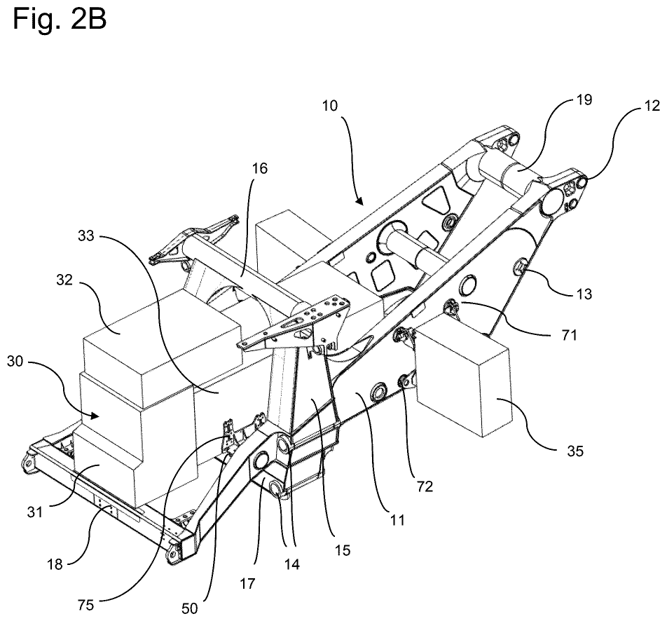

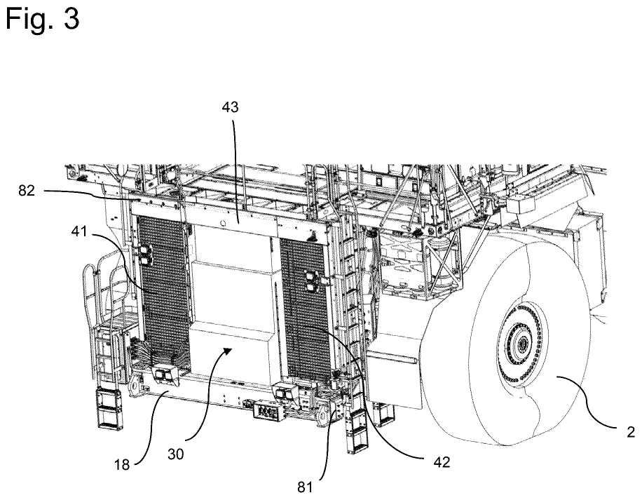

In the embodiment, as shown in FIG. 1, FIG. 3 and FIG. 4, the radiator unit is arranged on a front side of the battery electric dump truck. The position of the power unit within the installation space between the side beams 11 of the frame 10 is shown in FIG. 2B. The power unit is therefore inserted into the installation space from the front and removed from the installation space to the front through the installation opening 45.

In the embodiment, as shown in FIG. 1, FIG. 3 and FIG. 4, when the power unit 30 is installed to the battery electric dump truck, a front side of the power unit 30 is exposed to the surroundings and therefore a front surface of the power unit forms part of the front surface of the battery electric dump truck. In the embodiment, the front side of the power unit 30 extends in front of or between the radiator columns 41 and 42. In the embodiment, the front side of the power unit 30 closes the installation opening 45.

In the embodiment, the front side of the power unit is formed by at least one a casing element of the power unit.

In the embodiment, a power distribution cabinet 31 of the power unit 30 is provided on the front side of the power unit, and therefor accessible from the front side. In particular, as can be seen in FIG. 2B, the power distribution cabinet 31 may form a lower front part of the power unit. It may comprise a service door provided at the front side an accessible from the front of the dump truck.

Further, a high voltage shut-off switch may be arranged on the front side of the power distribution cabinet 31 and accessible by a person standing on the ground in front of the dump truck.

In the embodiment, the radiator unit extends in an up-down direction between the front cross member 18 of the frame 10 and the deck 5. In a lateral direction, it extends between the front ends of the side beams 11 of the frame 11. In the embodiment, the radiator unit is mounted behind and adjacent to the front cross beam 18, which therefore extends to the front side from the lower edge of the radiator unit 40.

In the embodiment, the two radiator columns 41 and 42 and the installation opening 45 are arranged symmetrically with respect to a center plane of the battery electric dump truck.

In the embodiment, the radiator columns 41 and 42 are mechanically coupled to each other by a cross beam 43 extending above the installation opening 45. In particular, the cross beam 43 extends below the deck 5. In the embodiment, the cross beam is provided by a metal frame element connected to the top side of the radiator columns 41 and 42 that extends over the entire lateral width of the radiator unit.

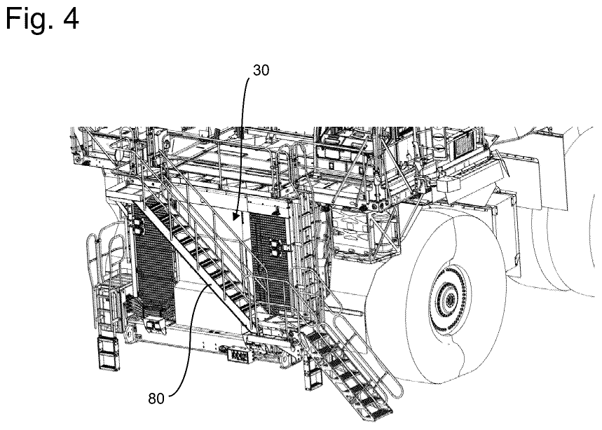

As shown in FIG. 5, each of the radiator columns 41, 42 comprises a plurality of fans 44 arranged above each other. In the embodiment, each of the radiator columns 41, 42 comprises three fans 44 arranged above each other, but embodiments with 2 fans per radiator column or more than 3 fans per radiator column are equally comprised in the present disclosure.

The fans move air across radiators of the radiator unit, i.e. across liquid-to-air heat exchangers, with the liquid side of the radiator or radiators of each of the radiator columns arranged in a coolant circuit.

In the embodiment, the coolant circuits of the radiator columns 41 and 42 are connected in series. In particular, coolant lines 48 connect the coolant circuits of the radiator columns 41 and 42 in series, with coolant pumps 47 arranged in the coolant lines 48. An inlet line 46 for heated coolant is connected to an inlet side of the coolant circuit of radiator column 42 and an outlet line 49 is connected to an outlet side of the coolant circuit of radiator column 41, or vice versa.

In the embodiment, the radiator unit 40 is configured to reject heat from the power unit 30. In particular, the power unit 30 may comprise a thermal conditioning unit for cooling the batteries. A coolant circuit of the radiator unit may be connected via the inlet line 46 and the outlet line 49 to a heat exchanger arranged in the thermal conditioning unit of the power unit 30 in order to exchange heat with a coolant circuit of a thermal conditioning unit cooling the batteries.

In the embodiment, as shown in FIG. 1 and FIG. 4, the battery electric dump truck comprises a staircase element 80 arranged in front of the installation opening 45. The staircase element provides access to the deck 5 from the ground and extends diagonally across the front of the battery electric dump truck.

In the embodiment, the staircase element 80 is removably attached to the battery electric dump truck. Thereby, it can be easily removed from the battery electric dump truck in order to provide access to the installation opening 45 and attached to the battery electric dump truck after the power unit has been replaced.

In particular, as shown in FIG. 3, a first mounting element 81 is provided on the front end of one of the side beams 11 and a second mounting element 82 is provided on the opposite side on the front side of the radiator unit below the deck, in particular on the cross beam 43 of the radiator unit, with the staircase element 80 removably attached, e.g. bolted, to the first and second mounting elements 81 and 82.

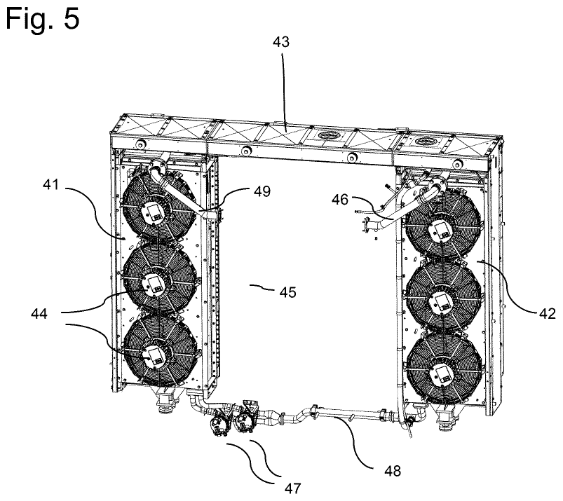

According to a second aspect of the present disclosure, as shown in FIG. 2A, FIG. 2B, FIG. 6A and FIG. 6B, the power unit 30 is mounted on cantilevered mounts 50 attached to the frame 10. In particular, in the embodiment, the cantilevered mounts 50 are attached to the inner side walls of the side beams 11 of the frame 10. According to the second aspect, the cantilevered mounts 50 are bolted to the frame 10.

Bolting the cantilevered mounts 50 allows to provide a frame that is agnostic to the type of power unit used for the truck, and adapt the frame 10 to the power unit by bolting on the appropriate cantilevered mounts 50. For example, the same frame can thereby be used with a battery electric dump truck and a dump truck powered by a combustion engine such as a diesel electric dump truck.

FIG. 6A and FIG. 6B shows embodiments of a cantilevered mount 50, 50′. The cantilevered mounts 50, 50′ comprise a connection plate for connecting to the frame 10 having bore holes 55 for receiving the screws 57 by which the cantilevered mounts 50, 50′ are respectively mounted to the frame. Further, they comprise a cantilevered mounting plate 56, 56′ on which the respective power unit is mounted. The cantilevered mounting plate 56, 56′ has bores for receiving screws and/or rubber bearing elements for mounting the power unit to the cantilevered mounting plate 56, 56′.

FIG. 6A shows a cantilevered mount 50 adapted to be used for the power unit of the present disclosure comprising batteries for powering the battery electric dump truck, while FIG. 6B shows a cantilevered mount 50′ adapted to be used for the power unit comprising a combustion engine and a generator for powering a combustion electric dump truck.

In the embodiments shown, the cantilevered mounts 50 and 50′ comprise a connection plate for connecting to the frame having the same bore holes 55 for the screws 57. The cantilevered mounts 50 and 50′ however differ with respect to the cantilevered mounting plate 56, 56′ on which the respective power unit is mounted.

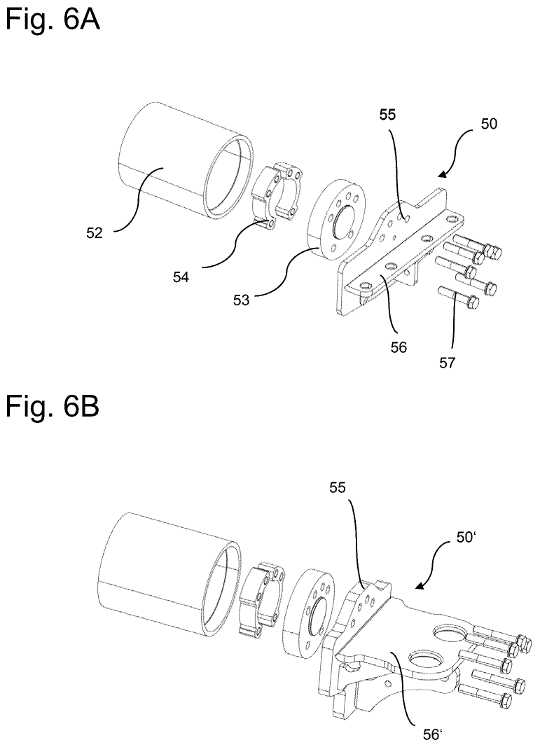

The cantilevered mounting plate 56 of the cantilevered mount 50 used for mounting a power unit 30 of the present disclosure is in particular configured such that brackets 75 and 76 attached to the power unit 30 as shown in FIG. 7 are mounted on the cantilevered mounting plate 56. There may be a single type or two types of cantilevered mounts 50 adapted to be used with the front and rear brackets 75 and 76 of the power unit, with the front and rear brackets 75 and 76 of the power unit differing in construction.

In the embodiment, as shown in FIG. 2A, FIG. 6A and FIG. 6B, the frame comprises frame tubes 52 extending in a lateral direction through the frame, and in particular through the side beams 11 of the frame, with the cantilevered mounts 50, 50′ being bolted to cover plates 53 of the frame tubes 52. The frame tubes improve the stability of the side beams 11 where the cantilevered mounts 50, 50′ are attached.

The frame tubes are welded to the surrounding steel plates of the side beams 11. Further, the cover plates 53 are welded to the frame tubes 52.

In the embodiment, the bolts 53 reach through holes provided in the cover plates 53 and are screwed into separate screw hole elements 54 arranged behind the cover plates. Thereby, it is not necessary to cut screw threads into the holes provided in the cover plates.

All the features described above or in the following for a battery electric dump truck equally apply for the dump truck according to the second aspect if the power unit is a combustion engine power unit rather than a battery electric power unit.

Further, the power unit may equally be hydrogen fuel cell power unit or a hybrid power unit comprising a combination of at least two of the technologies described above, i.e. combustion engine electric, battery electric and hydrogen fuel cell.

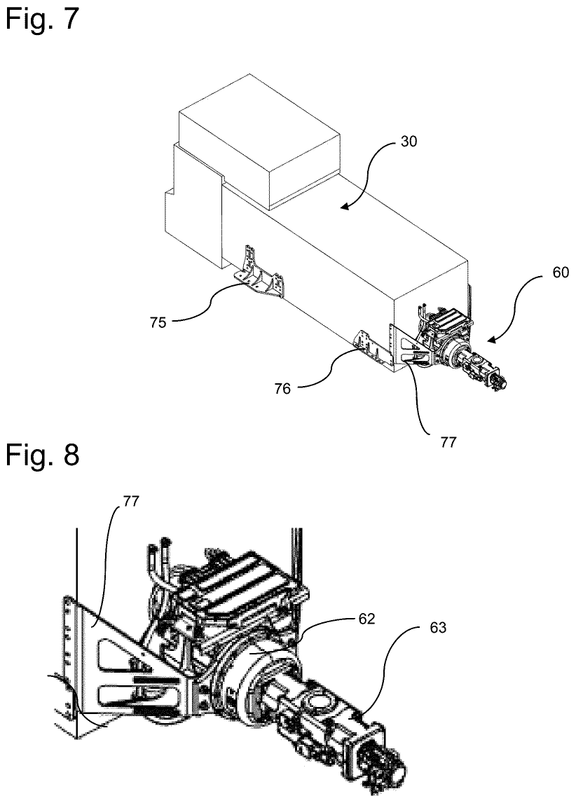

According to a third aspect of the present disclosure, as shown in FIG. 7 and FIG. 8, the battery electric dump truck comprises a hydraulic pump 63 operated by an electric motor 62, wherein the hydraulic pump 63 and the electric motor 62 are mounted to the power unit 30.

In a conventional dump truck powered by a combustion engine, the hydraulic pump is usually driven by the combustion engine, and e.g. arranged on the engine housing. With the arrangement of the hydraulic unit comprising the hydraulic pump 63 and the electric motor 62 on the power unit, there is no need to provide a separate mount for the hydraulic unit on the frame, such that the frame does not need to differ between a combustion engine version and a battery operated version of the dump truck.

In the embodiment, the hydraulic pump 63 and the electric motor 62 are arranged on a rear side of the power unit 30. This is the same place as for a usual combustion engine.

In the embodiment, therefore, the power unit 30 is mounted to the frame 10, and the hydraulic pump 63 and the electric motor 62 are only connected to the frame 10 via the power unit 30.

In the embodiment, a mounting bracket 77 for mounting the hydraulic pump 63 and/or the electric motor 62 is arranged on a rear side of the power unit 30. In particular, the bracket is screwed to the rear edges of the side walls of the power unit 30 and spans across the rear wall of the power unit in the lateral direction. The electric motor 62 is attached to a mount of the brackets 77, and the hydraulic pump is mounted on the motor 62.

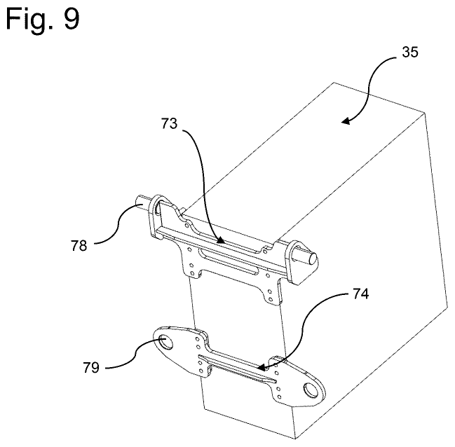

According to a fourth aspect of the present disclosure, as shown in FIG. 2B and FIG. 9, the battery electric dump truck comprises at least one additional battery unit 35, attached to the frame 10 at a position between the front and the rear wheels 2, 3 using a first bracket 73 comprising pins 78 inserted in hooks 71 provided on the frame. Thereby, the additional battery unit 35 can be easily replaced. Further, in an embodiment, the same connection elements can be used for the additional battery unit 35 that are used for additional fuel tanks in a combustion engine powered version of the dump truck.

In the embodiment, an additional battery unit 35 is provided on each lateral side of the battery electric dump truck. Further, the hooks 71 are provided on the outer side walls of the side beams. The hooks 71 and therefore the additional battery units are arranged at a longitudinal position in front of the pins of the cross member 19′ on which the hoist cylinders are mounted and therefore in front of the hoist cylinder.

In the embodiment, the additional battery unit 35 is attached to the frame 10 using a second bracket 74 connected by at least one rubber bearing to the frame 10.

In the embodiment, as shown in FIG. 9, the second bracket 74 is positioned below the first bracket 73.

In the embodiment, two rubber bearings attached to the frame 10 via two attachment points 72 are connected to opposite ends 79 of the second bracket 74.

In an embodiment, the first and/or second bracket 73, 74 can be used for connecting a fuel tank 35 in a combustion engine powered version of the dump truck. Therefore, the same frame can be used for a battery powered and a combustion engine powered version of the dump truck.

The first, second, third and fourth aspect described above are independent from each other, and may be employed independently from each other with the embodiment of a battery electric dump truck as described above, or with any other battery electric dump truck having a frame and a power unit mounted to the frame.

Further, the first, second, third and/or fourth aspects described above may also be combined with each other, with all combinations of the aspects comprised by the present disclosure.

In the following, methods according to the present disclosure will be described. These methods are independent from the aspects described above. However, in embodiments of the present disclosure, the methods may be applied to the dump trucks according to the first, second, third and/or fourth aspect described above.

According to a fifth aspect of the present disclosure, a method for installing or de-installing a power unit to or from a battery electric dump truck is provided. The battery electric dump truck comprises a frame and a dump body pivotably mounted on the frame, and the power unit comprising a battery and providing electrical energy to at least one electrical propulsion motor of the battery electric dump truck. The method comprises the step of inserting the power unit from a front side of the battery electric dump truck or removing the power unit to a front side of the battery electric truck via an insertion opening provided between two radiator columns of the battery electric dump truck, the radiator columns being provided on a front side of the battery electric dump truck. Therefore, the radiator unit does not have to be removed for inserting or removing the power unit, but can still be provided on the front side of the battery electric dump truck.

In the embodiment, the method comprises the step of dismounting a staircase element 80 arranged in front of the installation opening 45 before inserting or removing the power unit 30.

In the embodiment, the two radiator columns of the battery electric dump truck remain on the battery electric dump truck while the power unit is removed and replaced by a new power unit.

The method may in particular be employed with the battery electric dump truck according to the first aspect described above. Further, it may be performed as described above.

According to a sixth aspect of the present disclosure, a method for manufacturing a dump truck, is provided, the dump truck comprising a frame 10 and a dump body 20 pivotably mounted on the frame, and a power unit 30 powering a propulsion system of the dump truck, the method comprising the steps of providing the frame 10, choosing the power unit 30 from a battery electric power unit and a combustion engine power unit, and mounting the power unit 30 on the frame 10, wherein the frame is identical for the battery electric power unit and the combustion engine power unit. Using a frame that is agnostic to the type of power unit used may simplify manufacture and reduce costs.

In case that the power unit is a battery electric power unit, it may be configured as described above. In particular, it may comprise a battery unit 33 for powering electric traction motors of the dump truck. The power unit may also comprise a power distribution cabinet 31 and/or a thermal conditioning unit 32.

Further, in case that the power unit is a battery electric power unit, the dump truck may be configured as described above with respect to the battery electric dump truck of the present disclosure described above.

In case that the power unit is a combustion engine power unit, it may comprise a combustion engine driving a generator, the generator powering electric traction motors of the dump truck.

Further, in case that the power unit is a combustion engine power unit, the configuration of the dump truck may still be the same as described above for the battery electric dump truck of the present disclosure. However, in an embodiment, a radiator unit may be used that is arranged in front of the power unit and does not comprise an installation opening. In this case, the radiator may comprise a single, e.g. centrally arranged fan. This is because for a combustion engine powered dump truck, the combustion engine power unit does not have to be replaced over the usual service life of the truck.

In an embodiment, the method may comprise mounting the power unit 30 at the same position with respect to the frame 10 independently of whether the power unit is the battery electric power unit or the combustion engine power unit.

In an embodiment, the method may comprise mounting the power unit 30 on cantilevered mounts 50 bolted to the frame 10, wherein the cantilevered mounts 50, 50′ are chosen depending on whether the power unit 30 is the battery electric power unit or the combustion engine power unit. In particular, this step may be performed with a dump truck and/or cantilevered mounts as described with the second aspect of the present disclosure.

In an embodiment, the method may comprise depending on whether the power unit is the battery electric power unit or the combustion engine power unit, mounting an additional battery 35 unit or a fuel tank 35 to the frame 10 via a mounting bracket 73, 74, wherein the mounting bracket 73, 74 is identical for the additional battery unit and the fuel tank. In particular, this step may be performed with a dump truck and/or frame and/or mounting brackets 73, 74 as described with the fourth aspect of the present disclosure.

In an embodiment, the method may comprise mounting a hydraulic unit to the power unit regardless of whether the power unit is a battery electric power unit or the combustion engine power unit.

In particular, this step may be performed with a dump truck as described with the third aspect of the present disclosure if the power unit is a battery electric power unit.

In an embodiment, in case that the power unit is a battery electric power unit, the hydraulic unit comprises an electric motor for driving the hydraulic unit, whereas in case that the power unit is a combustion engine power unit, the hydraulic unit is driven by a combustion engine of the power unit.

The hydraulic unit and in particular a hydraulic pump of the hydraulic unit may provide hydraulic power to operate the hoist cylinder of the dump truck.

1. A dump truck, comprising:
a frame,
a dump body pivotably mounted on the frame, and
a power unit providing electrical energy to at least one electrical propulsion motor of the dump truck,
wherein the power unit is mounted on cantilevered mounts attached to the frame, and wherein the cantilevered mounts are bolted to the frame.

2. The dump truck of claim 1, wherein the frame comprises frame tubes extending in a lateral direction through the frame, with the cantilevered mounts being bolted to cover plates of the frame tubes.

3. The dump truck of claim 2, wherein the cover plates are welded to the frame tubes.

4. The dump truck of claim 2, wherein bolts extend through holes provided in the cover plates and are screwed into separate screw hole elements arranged behind the cover plates.

5. The dump truck of claim 1, wherein a different cantilevered mount can be bolted to the frame for mounting a power unit comprising a combustion engine to the frame in a combustion engine powered version of the dump truck.

6. A battery electric dump truck, comprising:
a frame,
front and rear wheels mounted on the frame,
a dump body pivotably mounted on the frame,
a power unit comprising a battery, the power unit providing electrical energy to at least one electrical propulsion motor of the battery electric dump truck, and
at least one additional battery unit,
wherein the at least one additional battery unit is attached to the frame at a position between the front and the rear wheels using a first bracket comprising pins inserted in hooks provided on the frame.

7. The battery electric dump truck of claim 6, wherein the additional battery unit is attached to the frame using a second bracket connected by at least one rubber bearing to the frame.

8. The battery electric dump truck of claim 7, wherein the second bracket is positioned below the first bracket.

9. The battery electric dump truck of claim 7, wherein two rubber bearings attached to the frame via two attachment points are connected to opposite ends of the second bracket.

10. The battery electric dump truck of claim 7, wherein the first and/or second bracket is configured for connecting a fuel tank in a combustion engine powered version of the dump truck.

11. The dump truck of claim 1, wherein the frame comprises two side beams extending in a longitudinal direction of the dump truck.

12. The dump truck of claim 11, wherein the power unit is arranged between the side beams.

13. The dump truck of claim 11, wherein the frame comprises an upper bridge member connecting the two side beams in a lateral direction, the upper bridge member comprising side pillars extending upwards from the side beams and an upper cross beam connecting the side pillars.

14. The dump truck of claim 11, wherein the side beams are connected in the lateral direction by at least a first rear cross member and a second rear cross member.

15. The dump truck of claim 11, wherein the side beams have an essentially triangular shape extending between a front end, the first rear cross member and the second rear cross member, with the first rear cross member being arranged at a rear corner adjacent to a pivot mount of the dump body and the second rear cross member being arranged at a lower corner of the triangular shape and carrying lower ends of dump hoist cylinders.

16. The dump truck of claim 11, wherein front ends of the side beams are connected by a front cross member.

17. A method for manufacturing a dump truck,
the dump truck comprising a frame, a dump body pivotably mounted on the frame, and a power unit powering a propulsion system of the dump truck,
the method comprising the steps of:
providing the frame,
choosing the power unit from a battery electric power unit and a combustion engine power unit, and
mounting the power unit on the frame, wherein the frame is identical for the battery electric power unit and the combustion engine power unit.

18. The method of claim 17, further comprising:
mounting the power unit at the same position with respect to the frame independently of whether the power unit is the battery electric power unit or the combustion engine power unit.

19. The method of claim 17, further comprising:
mounting the power unit on cantilevered mounts bolted to the frame, wherein the cantilevered mounts are chosen depending on whether the power unit is the battery electric power unit or the combustion engine power unit, and/or
depending on whether the power unit is the battery electric power unit or the combustion engine power unit, mounting an additional battery unit or a fuel tank to the frame via a mounting bracket, wherein the mounting bracket is identical for the additional battery unit and the fuel tank.

20. The method of claim 17, further comprising:
mounting a hydraulic unit to the power unit regardless of whether the power unit is the battery electric power unit or the combustion engine power unit,
wherein, if the power unit is the battery electric power unit, the hydraulic unit comprises an electric motor for driving the hydraulic unit, whereas if the power unit is the combustion engine power unit, the hydraulic unit is driven by a combustion engine of the power unit.
